(19) United States
(12) Patent Application Publication
(10) Pub. No.: US 2004/0080527 A1
(43) Pub. Date: Apr. 29, 2004

(54) System and method for designing storage area networks

(76) Inventor: Stephen J. Elliott, Sacramento, CA (US)

Correspondence Address: HEWLETT-PACKARD COMPANY, Intellectual Property Administration, P.O. Box 272400, Fort Collins, CO, 80527-2400, US

(21) Appl. No.: 10/282,684

(22) Filed: Oct. 29, 2002

(51) Int. Cl. G09G 5/00

(52) U.S. Cl. 345/734

(57) ABSTRACT

A user interface allows for simplified design of SANs while providing information for use in analyzing different configurations. Different SAN elements are represented in a user interface and may be selected and configured in different arrangements with real time information provided to design a system for a particular application. Using the interface, the advantages and disadvantages of a particular SAN configuration can be determined with respect to different characteristics of the system, including, price, expected performance and measured performance.

### FIELD OF THE INVENTION

The present invention relates generally to storage area networks, and more particularly to a system for designing and analyzing such networks that integrates performance modeling and cost analysis.

### BACKGROUND OF THE INVENTION

Storage area networks (SANs) provide high speed transmission of data between interconnected data storage devices, which may be separately controlled by different servers. SANs typically are designed for a specific purpose or application, and usually for integration into a larger network. Because the design and planning of SANs is complex and usually specific to a particular application or for use for a specific purpose, it is difficult, if not impossible to evaluate the many different aspects of the overall system (e.g., determine performance characteristics particularly versus price). It is particularly difficult to analyze the effects of changes to a proposed system design (e.g., the addition of a new device).

As recognized by the inventor hereof, known systems for designing networks, and in particular SANs, fail to provide a user-friendly interface allowing for viewing and analyzing the overall proposed network, including specific connections (e.g., switches and connection infrastructure). Further, these known systems provide very limited information with respect to the performance of the proposed network design. Therefore, it is difficult to fully analyze the system and determine whether changes are desirable or needed. Additionally, these systems fail to provide sufficient information to fully evaluate a proposed network design, such as when designing a SAN for integration into an existing network. Such information that may be desirable includes, for example, price, performance, configuration, interconnectivity and compatibility information, which facilitate decision making during the design process.

### SUMMARY OF THE INVENTION

The inventor has perceived a need for a system that provides a user-friendly interface for designing SANs that will operate as required (e.g., optimized for particular operating characteristics) upon implementation. It is desirable for the system to provide information at all stages of the design process, including real time feedback of such information (e.g., when changes in design are made) for use in on the fly analysis.

The present invention provides a system and method that allows for designing SANs using real time information that is updated when changes are made to a proposed design. Further, the present invention integrates performance modeling and cost to provide a readily understood comprehensive representation of a proposed SAN design. The present invention is preferably implemented as a web-based application, which may be written in any appropriate language, including, for example, Java to allow for compatibility with different operating systems.

Specifically, in one embodiment of the present invention, a display system for designing a storage area network is provided. The display system, which may be provided, for example, as an interface, includes a plurality of selectable elements (e.g., virtual icons) representing components for the storage area network, with the plurality of selectable elements adapted for virtual connection. A graphical representation of information (e.g., performance or storage versus price) relating to the storage area network created by the virtual connection of at least some of the plurality of the selectable elements is also provided. A GUI may be provided for displaying the plurality of selectable elements and the graphical representation.

Further, the graphical representation is preferably updated based upon changes to a selection of at least some of the plurality of selectable elements creating the storage area network. Additionally, a selection panel having the plurality of selectable elements represented therein and a design panel for designing the storage area network by virtually connecting at least some of the selectable elements from the selection panel may be provided. Each of the selectable elements may include properties (e.g., configuration information) associated therewith.

A method of designing a storage area network provided by the present includes building a virtual storage area network by displaying representations of components of the storage area network selected by a user, displaying representations of connections between the components of the storage area network indicated by the user, and displaying a performance characteristic of the virtual storage area network being displayed. The display of the performance characteristic is preferably automatically updated as the user selects or deselects components or changes connections between selected components.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1(a) is a block diagram of a server element representation that may be used in connection with an interface of the present invention;

FIG. 1(b) is a block diagram of a switch element representation that may be used in connection with an interface of the present invention;

FIG. 1(c) is a block diagram of a bridge element representation that may be used in connection with an interface of the present invention;

FIG. 1(d) is a block diagram of a SCSI line element representation that may be used in connection with an interface of the present invention;

FIG. 2 is a block diagram of an interface constructed according to the principles of the present invention for use in designing SANs;

FIGS. 3(a) and 3(b) are block diagrams showing information that may be provided in connection with elements used for designing a SAN according to the present invention;

FIG. 4 is another block diagram of an interface of the present invention; and

FIG. 5 is a block diagram showing options available using an interface of the present invention.

### DETAILED DESCRIPTION OF THE PREFERRED EMBODIMENTS

The following description of the preferred embodiments is merely exemplary in nature and is in no way intended to limit the invention, its application, or uses. Although a system and method of the present invention for designing SANs is configured as an interface in a particular manner and calculates performance and other information based on specific factors, it is not so limited, and other configurations may be provided using different factors to calculate different information.

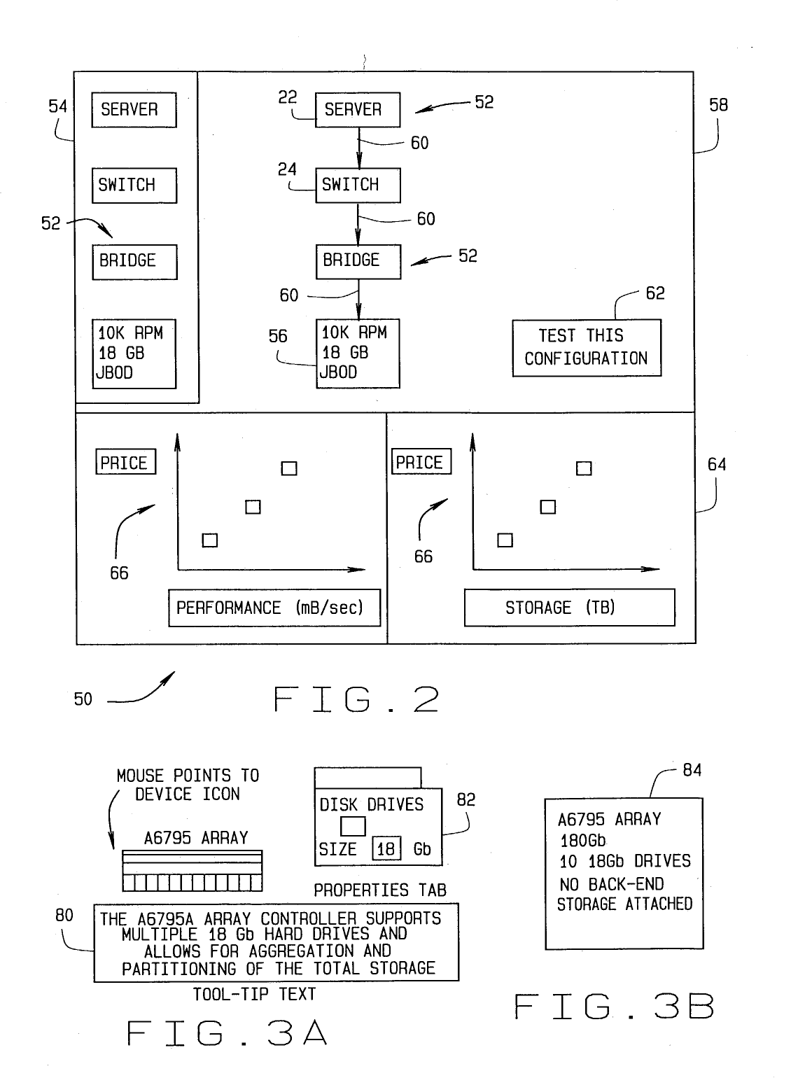

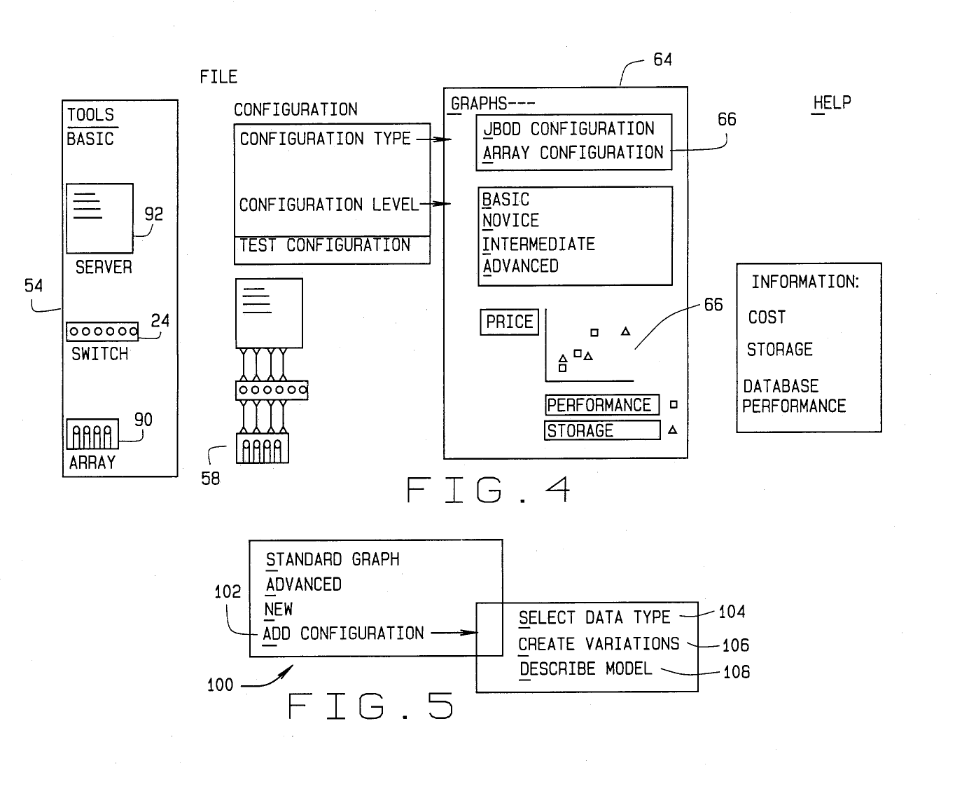

In general, the present invention provides a user interface preferably implemented as a “paint type” program as shown in FIGS. 2 and 4, with additional functionality easily added. This “paint type” program generally includes various elements that can be selected to design a SAN. For example, the elements may be selected from a list of standard configurations or elements shown as icons or accessed similar to CAD packages. They may also be provided as text elements or as elements that can be accessed through programming (e.g., LISP, script language, or VB). Further, the “paint type” functionally allows for a proposed SAN design to be graphically represented, and may display, for example, a layout relating to a particular end-site, with the wiring and the configuration of the particular SAN elements shown in one window of the display and associated reports shown in another window of the display as described in more detail herein.

Further, when implemented as part of a web-based application, the present invention may include “shopping cart” functionality (e.g., to purchase the products represented by the elements in the SAN design). Additionally, implementation as part of a web-based application allows users to access the application, for example, in a restricted way (via the Internet), thereby facilitating the exchange of cookies to enhance the application (e.g., connection information regarding a particular user already known). The web-based application may be implemented in any known manner, such as, for example, residing on a central server and/or partially downloaded and run from a client (e.g. local computer). Also, using a web-based application, updates can be made in a transparent manner to keep information (e.g., SAN component performance information) current, as well as to facilitate the collection of additional information, such as, for example, current marketing data or to provide support.

Key attributes are preferably provided in a graphical form, which may include, for example, performance versus cost. It should be noted that the program for implementing the interface according to the principles of the present invention may be written in any suitable form (e.g., an applet or in postscript).

Designing a SAN or other similar network (e.g., Ethernet networks, iSCSI networks, networks where storage is attached using file systems such as NFS, or other networks that operate on using Fibre Channel technology) using the present invention allows access to information that facilitates the design process, and allows for design changes with real-time feedback provided to determine the effects on the overall system. Information regarding, for example, price, performance, configuration, interconnectivity, compatibility and overall operation for a particular design is updated based upon changes to the proposed design. Essentially, a user can model a network (e.g., a SAN) using a graphical user interface (GUI) and determine the advantages or disadvantages of the particular design in relation to particular parameters, including generally price, expected performance and measured performance. Thus, an overall visualization of a particular network (e.g., SAN) is provided and may be modified with the effects of the modification easily determined. Further, using an interface of the present invention, comparisons of different real-time information relating to the design of a network can be made. For example, a price versus performance tradeoff analysis can be performed.

In general, an interface of the present invention, which is preferably implemented as part of a web-based application, allows for easy design and analysis of a SAN. For example, factors, such as, the revolutions per minute (RPM) of a disk drive, the size of reads and writes, as well as the architecture of a local area network (LAN) may be analyzed. With respect to the architecture of the SAN, various connections within the SAN (e.g., connections to a switch, bridge and disk drives) may be modified and analyzed on the fly. Using real-time information relating to these factors, the interface preferably calculates and graphs performance and price information for the particular SAN configuration.

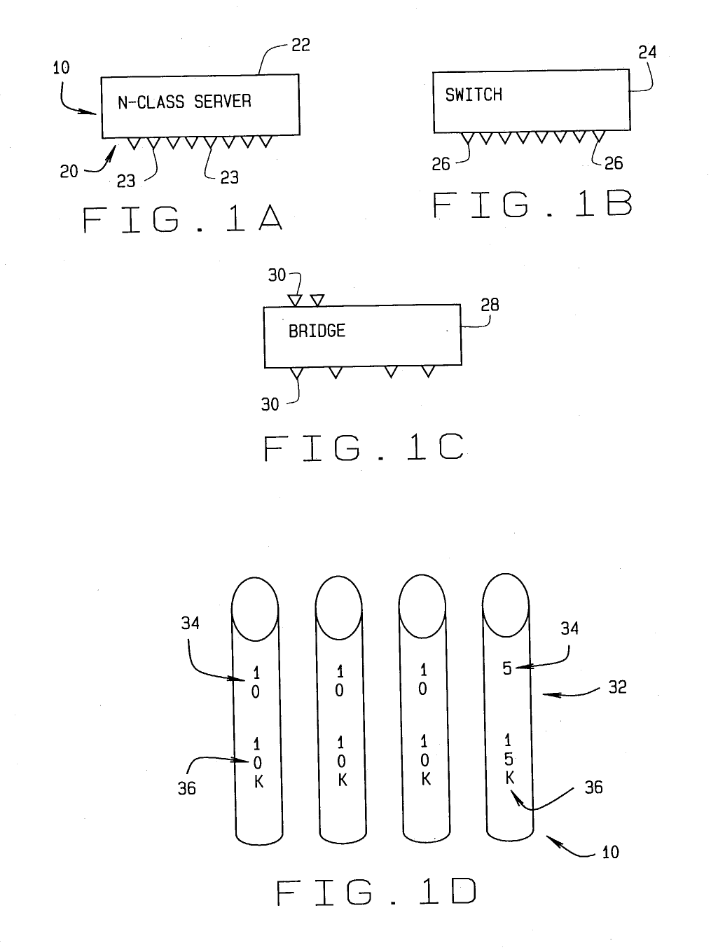

In particular, and in one embodiment as shown in FIGS. 1 through 4, virtual elements or objects 52 (e.g., an icon) are provided for each component that may be selected as part of the SAN (e.g., proposed SAN design). The virtual elements or objects 52 may have an associated picture with description or plain text relating to the particular component. Further, arrows or other similar members may be provided to indicate specific connections (e.g., Fibre Channel connections). For example, and with respect to designing a SAN, different common SAN components may be provided including, for example, N-class servers 22, switches 26 (e.g., 8-port switches), Fibre Channel SCSI multiplexer modules, Megatron JBODs (just a bunch of disks) and disk drive modules. Each of these components preferably includes specific connection capability and property information associated therewith. For example, a JBOD may have specific properties that define the number of drive modules and the kind of drive modules that can be provided therewith. Further, and for example, with respect to a server 22, properties of the server 22 may include the connections to which nodes of the server are connected.

In particular, the following components and associated properties for use in designing a SAN are preferably provided:

Properties

| Component | Subcomponents | Variables |
|---|---|---|
| 1. Storage server | Operating system | Windows, UNIX |
| | HBA cards | Manufacturer, speed |
| | Network cards | Ethernet, IFOP |
| | Memory | # of MB |
| | Local Storage | # of drives, drive size |
| | Boot location | Network, local or SAN |

It should be noted that HBA cards may be selected in a virtual manner for connection within the server, as well as with network cards, memory, and local storage forming a relationship between the subcomponents, the associated variables and the associated main component.

Properties

| Component | Subcomponents | Variables |
|---|---|---|
| 2. Upper level apps | Database | Transaction model, usage, |
| | | users |
| | Mail Server | Mail usage analysis/model |
| | Web Server | # of web pages |
| | | Resources required per page |
| 3. Network | Card configuration | Speed, Type |
| Connectivity | Router/bridge layout | Topology, Speed, Class |
| 4. Storage topology/ | Type of storage | JBOD, Array |
| configuration | Topology | Loop, Fabric, 1 Gb/s |

It should be noted that databases can be modeled on application servers and similarly with mail servers and web servers. Similar relationships can be established with network connectivity and storage topology/configuration.

Using information with respect to the specific components as described above, rules of connection are provided in topologies listed. For example, and with respect to a server 22, it may have a limitation as to the type and number of HBA cards that are supported in particular slots of the server. An A-class server, for example, may be limited to four HBA cards and may not need a separate network card. Thus, the information is used to determine and enforce rules concerning, for example, whether a particular connection is possible and supported.

Further, and for example with respect to topology rules, with a fibre channel system, differently topologies may not be mixed without use of an appropriate switch (e.g., bridge-capable switch). Thus, private hosts in the loop topology may not access public targets. Additionally, similar topology rules may be enforced relating to zoning or other support rules.

More preferably, a recommended topology is generated. A recommended topology (or other characteristic) can be embedded as a rule. For example, with the direct connection of an HBA card to a JBOD, the topology is a loop. With the connection of the HBA card to a bridging switch and the bridging switch to a JBOD, the recommended topology for the HBA card to the switch is a fabric. The recommended topology for the switch to the JBOD is a loop. The topology and physical configuration of storage can affect performance, expected reliability, service cycles, and maintenance requirements, particularly in the case of larger SANs.

The elements of the SAN are displayed graphically, and information regarding the connection capability of each of the components is provided therewith. For example, and as shown in FIG. 1(a), each connection 20 of a server 22 includes the properties of the connecting node, including the option of none, and the connecting object. As shown therein an n-class server with multiple Fiber-Channel optical connections is provided. Each optical connection is shown as an arrow 23. Thus, in a standard fabric configuration, specific rules (e.g., connection rules and requirement) may be provided based upon the specific requirements of an element. For example, each server 22 may connect only to a switch 24 (or multiple switches), and each switch 24 may only connect to a bridge 28. Further, each of the SCSI cards on the bridge 28 may attach only to a storage device.

Using these rules and/or requirements, connectivity rules for a particular element can be provided and enforced. For example, one rule may be that a server 22 may only connect to, a switch 24 because of the rules of this particular configuration. Another rule may be that each server node may only connect to either nothing or a single switch node. Further, and for example, for the nodes of a switch 26, similar properties and rules for this configuration may be provided. The switch node may connect to nothing, to an HBA card (at either 1 Gb/s or 2 Gb/s dependent on the type of HBA card) or to a free node on the bridge at 1 Gb/s in a loop topology. Additionally, each SCSI card node may attach to 1 JBOD, or nothing in this example. As should be recognized by one skilled in the art, rules (e.g., connection rules) may be developed and enforced for all elements.

For further example, and as shown in FIG. 1(b), the properties of a switch 24 may include the designation of each connection 26 (e.g., server, bridge or none) of the connecting node. Connecting nodes in general represent any devices or objects that have one connection relationship if separated and a different relationship if physically connected or within close proximity to another device. An example of these nodes are disk drives that can be placed within a disk drive bay or removed. In the case of a switch 24 that has many nodes capable of connection, the relationship may be more narrowly defined dependent on the node to which a connection is to be established. A connection from a single switch 24 to itself could for a standard configuration be called incompatible or designated as now allowed. The switch 24 may only be able to connect to HBA cards in a fabric topology at 2 Gb/s for server end-nodes.

When a connection is made, for example, between the switch 24 and the host (e.g., server 22), the validity of the connection may be shown in color, with green representing that the standard configuration rules are followed, yellow for violating the standard configuration rules, but allowed within nonstandard configurations, and red if the connection configuration is known to have definite issues.

Further, and for example, additional information may be used and provided with respect to connecting together element. For a server 22, if a QL topology is not allowed at 2 Gb/s, then this may be displayed. Similar designations can be provided for nodes of the bridge 30 at the fibre-channel side (i.e., the two connection arrows shown on top of FIG. 1(c)), wherein the nodes can only operate in the loop topology at 1 Gb/s in this given example. Thus, if one of the properties of the switch node is that it is designated locked into the fabric topology or 2 Gb/s speed, the connection is designated as incompatible.

As shown in FIG. 1(c), the properties of a bridge 28 may include the connections 30 (e.g., FC and SCSI). As shown in FIG. 1(d), the properties of SCSIs lines 32 may include the number of disks indicated at 34 and the speed of the disks indicated at 36. It should be noted that other components with associated properties may be provided as described herein.

In one embodiment, as shown in FIGS. 3(a) and 3(b), a user may obtain information regarding an element or connection by, for example, highlighting or pointing to the element using a computer mouse. In this embodiment the list 80 of the properties of the element using tool-tip text is provided and is preferably capable of modification using a properties tab 82. In an alternate embodiment, a separate frame 84 within the display may be provided that lists the most important properties.

Having described various components that may be selected to design a SAN using an interface of the present invention and the associated information that may be provided therewith, an interface 50 (e.g., a GUI displayed on a monitor of a computer system) of the present invention includes specific components (i.e., elements) that are represented as virtual objects 52 as shown in FIG. 2. More preferably, the virtual objects 52 are selected from a “paint like” selection panel 54 and may be modified (e.g., moved in the GUI) depending on particular configuration needs. Preferably, a base system is provided that may include, for example, a single server 22 connected to a switch 24 and to a set of 10 k RPM disk drives 56.

It should be noted that if the base system or model is not sufficient to meet the storage needs, it can be expanded, for example, using a SCSI bridge 28 (intermediate level), or with a switch 24 and many bridges 28 (advanced level), or with multiple switches 24 and multiple bridges 28, with their associated JBODs, thereby providing an advanced maximum configuration within a configuration set. It should be noted that in the base system configuration, SCSI HBA cards may be used on the host side so that a bridge 28 is not necessary. Base configuration rules may be enforced as a way to assist a user (e.g., SAN designer), and may be provided as a menu command (e.g., “fix this SAN design”).

With respect to the intermediate configuration, the bridge 28 allows for an upgrade of the base configuration with minimum impact. The bridge 28 allows a user to maintain access to previously generated data while providing expandability options. Thus, by including the bridge 28 in, for example, a SAN design, the user can be made aware of the optimal upgrade path from the base configuration to the chosen configuration through a warning message (e.g., “adding a bridge necessitates replacing the SCSI HBA cards with FC cards.”). Further, information in a side panel as well as an automatic dialogue box offering to bring the configuration to standard may be provided.

In operation, and as shown in FIGS. 2 and 4, virtual objects 52 are selected (e.g., point and click with a computer mouse) from the selection panel 54 and moved (e.g., drag and drop with a mouse) to a design panel 58 of the interface 50. The orientation and connection of the various virtual objects 52 may be modified simply by moving the virtual objects 52 and creating the specific desired connections, which as shown, are represented by virtual arrows 60. The virtual arrows 60 are preferably provided as part of icon, which is selected from among the list of standard tools with standard properties for a selected configuration associated therewith (e.g., for an eight-port switch wherein there are eight fibre-channel connections in the standard configuration). The number of virtual arrows 60 may be modified based upon the number of optical connections (e.g., if only six optical interfaces are to be included, six arrows are provided).

Referring now to FIG. 4, and an another exemplary SAN design provided using an interface 50, storage arrays 90, switches 24, and servers 92 may be used in an array configuration set. The base configuration consists of one server 92, a single switch 24 and a disk array 90 selected from the selection panel 54 and connected together within the design panel 58. In an intermediate configuration, multiple servers 92, daisy-chained switches 24, storage arrays 90, and tape-backup devices may be provided. In an advanced configuration within this configuration set, the configuration provides high-availability over long-distance (e.g., <120 km) with redundant storage, switches 24, and tape-backups. It should be noted that the interface 50 may allow for selection of either a base, intermediate or advanced configuration to begin the SAN design process using the present invention.

A user, upon completing a particular SAN design, or at any stage of the design process (e.g., upon redesigning a particular SAN configuration by adding or removing a virtual component 52) may test the particular design (i.e., configuration of virtual components 52). For simple configuration rules, the properties or compliance to these rules may be determined real-time, for example, by highlighting incorrect connections, etc. However, for more complicated simulations (e.g., E-mail server performance or database performance), more complicated modeling may be used. For example, if a user wants to determine the percent improvement in the SAN performance of one configuration versus another, a performance test may be provided over a period of time based on usage levels.

Preferably, a virtual test button 62 (e.g., “Test this configuration”) is provided and selected when a test is desired. It should be noted that when reference is made to “selecting” an element or button, this refers to using a mouse or other similar device to point to the element with a virtual pointer and click the mouse to select that element. However, with some other interface, this selection can be accomplished by some other means. When moving an element, a mouse button may have to be maintained in a depressed state until the element is moved.

Upon initiating a test (i.e., clicking the virtual test button 62) performance data regarding the designed SAN is provided. In particular, a performance panel 64 is preferably displayed that includes one or more graphic or text displays, such as, graphs 66, which are preferably displayed showing predetermined information relating to the proposed SAN in the design panel 58. As shown in FIG. 2, and for example, a graph 66 of price versus performance information and a graph 66 of price versus storage information may be provided. These text and graphic informational displays are updated each time the user requests a test (e.g., by clicking the test button 62) and will take into account the addition, deletion or substitution of elements. The graphs 66 of performance versus storage and price versus storage are preferably displayed in separate frames, for example, to allow a user to score and rate various SAN options in terms of measurable characteristics. Each data point in the graphs 66 represent a particular configuration and set of properties. Thus, when a user selects (e.g., clicks on with a computer mouse) one of the data points, the associated configuration is displayed. If a user selects a different configuration type, an additional data point is displayed, for example, in a highlighted color so that the user can compare a “custom” configuration versus standard configuration.

Further, a graph menu 100 may be provided as shown in FIG. 5. More preferably, standard graph options allow for the selection of more commonly used features, for example, features relating to storage quantity versus price. By selecting the “Add configuration” option 102 shown in FIG. 5, the characteristics of this option can be displayed. The graph menu 100 allows the user to select the type of data to be graphed using a “Select data type” option 104. The standard quantities may be, for example, performance and storage versus price. However, other quantities such as reliability versus price and total cost may also be selected to be the basis of the x or y axis on the standard graph types. The “Create variations” option 106 creates a few configuration variations that vary slightly in the quantities of interest so that the user may understand what options are best to pursue. The “Describe model” option 108 provides for generating a report detailing how the graph results were obtained.

With respect to calculations performed by the interface 50, and in particular the cost component calculation, because each of the physical component parts is represented as either an icon or other similar representation, the total list cost of a configuration can be calculated as the sum of the component costs and any applicable discounts. With respect to the performance component, this can be determined based upon information associated with each of the devices. For example, disk drives for random records and writes have two fundamental limits, the IOPS (Input Output Per Second) limit and the MB/S limit This is the performance of an individual disk drive. With many disk drives operating in parallel, each drive contributes operations per second in terms of aggregate throughput through the SAN with some overhead from the switch and the HBA card, which are together added to provide performance information. There are similar maximum throughput numbers for the SCSI bus and for the fibre channel bus, as well as for the HBA card. Thus, using a simple model, or even a more sophisticated model, the user can have a basis for comparing one SAN configuration against another and calculating list cost and performance.

Different general categories of information also may be selected and compared in the graphs 66, such as, for example, “expected to work” versus “tested”, “supported” and “not recommended”. Specifically, the “tested” configuration may be identified in the graph 66 as a bright green data point. The “expected to work” configuration may be represented with a yellow-green data point. The “supported configuration” may be shown as a yellow data point. The “not recommended” configuration may be shown as an orange data point. Unsupported configurations may be represented with a red data point on the graph so that the user is provided with an engineering recommendation for particular configurations. Updated information can also be provided with the list 80 provided as part of the tool-tip text so that when the mouse cursor is placed over a data point, the description of the supportability is displayed by the interface 50.

It should be appreciated by one of ordinary skill in the art that the present invention may be implemented using different programming languages or applications (e.g., CGI scripts, visual basic or CAD) running on different platforms. Further, different drawing programs (e.g., Visio) may also be used to create the different virtual components of the present invention. These elements may also be taken from pictures of the individual subcomponents. The elements may be pieced together using a custom scripting language in addition to standard languages, such as C/Ctt, LISP, LOGO, VB, VB script, assembly, JAVA, Fortran as well as standard display interfaces such as postscript, x-windows, Windows®, to name only a few.

With respect to the various objects (e.g., virtual elements or objects 52) displayed by the interface 50, in general, these objects are either a box icon (e.g., virtual element or object 52) or an arrow 60. A box has the properties of dimensions (i.e., x1, y1, dx, dy) and a label. The methods for implementing the box preferably include “eraseBox” and “paintBox” subroutines. The “erase box” subroutine is used when the user selects an icon to be deleted. It basically removes the icon from the list of icons and connections that are to be painted on the display (i.e., design panel 58). The “paint box” subroutine is used to paint an icon on the screen during initialization of the screen, for example, when the screen needs to be refreshed or when an additional virtual element or object 52 is to be added into the SAN.

Also, when a mouse is clicked within the box, it must select the box. This can be accomplished by moving the box to the end of the repaint list so that the last selected box is repainted last. In order for the box to be dragged, the mouse click must also select a box, setting the appropriate variable so that “eraseBox” and “paintBox” subroutines can be executed to move the box. Properties of the box are also included and provided by a “selectedBox” subroutine which indicates the box that is selected, and x1min, x1max, y1min, y1max that indicate the range over which the box can be moved.

Implementation of a virtual arrow 60 is similar to a box. For example, it may be constructed as a filled rectangle with a tip. Thus, by adding a “tippedBox” subroutine, all the methods for the box described herein can apply. The tip is just applied in the longitudinal dimension. A first subroutine may create the box and allow its motion and scaling, and a second subroutine may create an arrow for the box.

In particular, in order to handle the processes of responding to when a mouse is placed over an icon or over a connection event, handling routines are generated for each of the elements. When a user clicks on a data point on a graph, for instance, an event is generated that is processed by the event handler routine, redrawing the configuration on-screen with visual basic, with the programming language and operating system facilitating the programming of event handlers. For some languages, it may be necessary to create a baseline of generic routines for properly handling events such as mouse trespassing or clicking on particular objects. It should be noted that the routines and subroutines may be implemented as needed or required by the particular programming language or operating system.

The interface 50 may also provide additional options. For example, the interface 50 may include a demonstration mode wherein basic product line capabilities are demonstrated. The demonstration may generate various combinations for a user and plot standard characteristics on a graph. It may also include audio music and visual components. For example, a single data point on a graph showing the most advanced configuration may be provided to represent the largest configuration possible. Further, the demonstration may be set, for example as a screen saver. The demonstration can be accessed using command line options on particular URL addresses in the case of a web-based application. Once initiated, the demonstration preferably proceeds automatically (e.g., screen by screen) or may be paused to go back and forth between configurations.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A display system for designing a storage area network, the display system comprising:
a plurality of selectable elements representing components for the storage area network, the plurality of selectable elements adapted for virtual connection; and
a graphical representation of information relating to the storage area network created by the virtual connection of at least some of the plurality of the selectable elements.

2. The display system according to claim 1 wherein the information comprises performance versus price information.

3. The display system according to claim 1 wherein the information comprises storage versus price information.

4. The display system according to claim 1 further comprising a graphical user interface for displaying the plurality of selectable elements and the graphical representation.

5. The display system according to claim 4 wherein the graphical user interface is configured for web-based operation.

6. The display system according to claim 1 wherein the information is adapted to provide notification of a storage area network that is inoperable.

7. The display system according to claim 1 wherein a predetermined set of selectable elements are provided.

8. The display system according to claim 1 wherein the graphical representation is updated based upon changes to a selection of at least some of the plurality of selectable elements creating the storage area network.

9. The display system according to claim 1 further comprising a selection panel having the plurality of selectable elements represented therein and a design panel for designing the storage area network by virtually connecting at least some of the selectable elements from the selection panel.

10. The display system according to claim 9 wherein a base set of selectable elements are initially provided and virtually connected within the design panel.

11. The display system according to claim 4 wherein the selectable elements comprise virtual icons.

12. The display system according to claim 11 further comprising virtual arrows representing the virtual connections.

13. An interface for designing a storage area network, the interface having graphical and textual content and comprising:
a first section having selectable elements representing components of the storage area network, each of the elements having textual content for identification; and
a second section having a graphical representation of selected information relating to the performance of the storage area network configured in the first section.

14. The interface according to claim 13 further comprising a predetermined set of selectable elements.

15. The interface according to claim 14 wherein the predetermined set of selectable elements comprise properties associated with each element.

16. The interface according to claim 15 wherein the properties comprise configuration information.

17. The interface according to claim 13 further comprising a selectable testing button adapted for activation to test a plurality of selectable elements virtually connected within the first section.

18. The interface according to claim 13 wherein the first and second sections are adapted for display on a graphical user interface with the selectable elements represented as icons.

19. An interface for virtually designing and analyzing a storage area network, the interface comprising:
means for identifying the components of the storage area network and virtually connecting the components; and
means for providing performance information relating to the virtually connected components.

20. The interface according to claim 19 further comprising means for testing the virtually connected components.

21. The interface according to claim 19 further comprising means for displaying the virtually connected components.

22. A method of designing and analyzing a storage area network, the method comprising:
virtually connecting a plurality of elements representing components of the storage area network; and
representing graphically performance information relating to the virtually connected plurality of elements.

23. The method according to claim 22 further comprising comparing performance information to price information to be represented graphically.

24. The method according to claim 22 further comprising means for displaying the virtually connected plurality of elements and the graphical performance information.

25. The method according to claim 22 further comprising associating property information with each of the plurality of elements.

26. A system for designing a storage area network, the system comprising:
a display including at least a first portion for displaying a virtual storage area comprising representations of selected components of a storage area network and representations of selected connections between the representations of selected components; and a second portion for displaying a performance characteristic of the virtual storage area network.

27. The system according to claim 26 wherein the display displays representations of a plurality of possible components of a storage area network, and includes a input device for selecting components from the displayed possible components.

28. The system according to claim 26 further comprising an input device for indicating connections between selected representations of components of a storage area network, and wherein the system displays representations of the indicated connections.

29. The system according to claim 26 wherein the performance characteristic is displayed as a graph of system price versus performance for the configuration of the virtual storage area network.

30. The system according to claim 26 wherein the system further includes a trigger for causing the system to update the display performance characteristics.

31. The system according to claim 26 wherein the system automatically updates the display of performance characteristics when changes are made to the virtual storage area network.

32. A method of designing a storage area network comprising building a virtual storage area network by displaying representations of components of the storage area network selected by a user; displaying representations of connections between the components of the storage area network indicated by the user; and displaying a performance characteristic of the virtual storage area network being displayed.

33. The method according to claim 32 wherein the display of the performance characteristic is automatically updated as the user selects or deselects components or changes connections between selected components.

34. The method according to claim 32 wherein the display of the performance characteristic is updated after the user selects or deselects components or changes connections between selected components only upon a specific action by the user to trigger the update.
